(19) United States
(12) Patent Application Publication
(10) Pub. No.: US 2025/0101267 A1
(43) Pub. Date: Mar. 27, 2025

(54) SUPERHYDROPHOBIC COATINGS, COMPOSITIONS AND METHODS

(71) Applicant: THE UNIVERSITY OF BRITISH COLUMBIA, Vancouver (CA)

(72) Inventors: Damon J. GILMOUR, Vancouver (CA); Tanja TOMKOVIC, Vancouver (CA); Savvas G. HATZIKIRIAKOS, South Surrey (CA); Laurel L. SCHAFER, Vancouver (CA)

(21) Appl. No.: 18/713,142

(22) PCT Filed: Nov. 23, 2022
(86) PCT No.: PCT/CA2022/051722

§ 371 Date: May 23, 2024

Related U.S. Application Data
(60) Provisional application No. 63/283,191, filed on Nov. 24, 2021.

(51) Int. Cl. C09J 7/38; C09J 5/00; C09J 7/24; C09J 7/25; C09J 7/40

(52) U.S. Cl. CPC C09J 7/38; C09J 5/00; C09J 7/243; C09J 7/25; C09J 7/401; C09J 2203/35; C09J 2301/16

(57) ABSTRACT

Provided herein are multilayer structures comprising superhydrophobic coatings, methods of making, and methods of using. Also set forth herein are improved adhesives with include PTFE or other fluoropolymers as a superhydrophobic surface. Also set forth herein are improved adhesives with can be applied as a paint to a surface. These superhydrophobic surfaces are useful for a variety of applications, including, but not limited to, drag reduction, as an anti-fouling surface in marine engineering, and as sealants and gaskets in static applications.

### CROSS-REFERENCE TO RELATED APPLICATIONS

This application claims priority to, and the benefit of, U.S. Provisional Patent Application No. 63/283,191, filed Nov. 24, 2021, and titled SUPERHYDROPHOBIC COATINGS, COMPOSITIONS AND METHODS, the entire contents of which are herein incorporated by reference in their entirety for all purposes.

### FIELD

The present disclosure concerns multilayer composite structures having superhydrophobic coatings secured to (e.g., bonded to) water-resistant adhesives, articles comprising same, processes of making the same, and methods of using same.

### BACKGROUND

Common polymeric motifs used for adhesives are epoxies, acrylics, and polyurethanes. The effectiveness and strength of bonding of these conventional adhesives is dramatically lower in aqueous environments compared to dry environments. An especially challenging environment is under immersion in solutions, particularly those with non-neutral pH or elevated ion content (for example, brine and other liquids with a high concentration of ions). In aqueous environments in general, and salt water in particular, surface attachment or bonding of an adhesive material to a substrate is more complex due to the added interactions between the surface and adhesive with the water and with other ions present.

Most examples of underwater adhesive technologies have been developed based on so-called mussel-inspired adhesives. These are generally based on polymers with a combination of catechol and styrene motifs. See, e.g., U.S. Pat. No. 11,046,873 B2. In these systems, it has been determined that variations to the polymer structure are required for optimized adhesion in either a dry or wet environment. A common feature of these adhesives, however, is that they are cured and non-reversible. When bond failure or delamination occurs, the substrates cannot be rejoined with the same adhesive strength as when originally combined.

Superhydrophobic surfaces, or surfaces with extremely low surface free energy, represent an extremely challenging substrate for adhesives and are often known to have poor mechanical properties that limit their broad application. See, for example, Zhu, et al. Journal of Materials Chemistry 2011, 21 (39), 15793-15797; Chen et al. Advanced Materials Interfaces 2016, 3 (6), 1500718.-2. Due to their low surface free energy, these coatings are susceptible to abrasion and other mechanical deformations and are also challenging to bond to substrates. Accordingly, while fluoropolymers such as PTFE can be used to produce highly desirable surfaces with extreme hydrophobicity or superhydrophobicity, they are difficult to process as a coating or lubricant due to low solubility. See, for example, Pradhan, et al. Polymer-Plastics Technology and Materials 2019, 58 (5), 498-518. Moreover, their poor adhesion with other surfaces, the lack of suitable adhesives that can be easily applied, and the lack of suitable adhesives that are environmentally safe, has prevented the widespread use of PTFE in many technologically important applications. See, for example, Sheng, et al. Journal of Adhesion 2017, 93 (9), 716-733; Jin et al. Macromol. Rapid Commun. 2014, 35 (18), 1551-1570.

A significant and growing need exists for materials that can coat surfaces and provide enhanced antifouling and/or modified wetting behavior. Biofouling and biofilms, in particular, are costly problems that impact ecological and human health, infrastructure, carbon emissions, and machine performance. In marine environments, for example, biofilms as thin as 50 μm can increase drag on a ship by more than 20%, resulting in significant economic and environmental consequences. Indeed, an estimated 70 million tons of additional CO₂ is produced by the United States Navy as a consequence of the increased fuel consumption due to biofilms. Estimates indicate fouling in marine industries in general may generate costs greater than $6.4 billion (US) per year.

What is needed, then, are improved adhesives that are useful with PTFE and other fluoropolymers in hydrophobic and superhydrophobic coatings for drag reduction, as an anti-fouling surface in marine engineering, and as sealants and gaskets in static applications. New compositions and processes are also needed adhering these types of coatings to large and/or irregular substrates, and for using them in aqueous environments and marine engineering in particular. The present disclosure addresses these and other unmet needs.

### SUMMARY

In one embodiment, set forth herein is a composite structure comprising a substrate and a hydrophobic coating disposed on a surface of the substrate, wherein the hydrophobic coating comprises a water-resistant adhesive layer comprising an amine-functionalized polymer having a uniform thickness of between about 1 μm to about 500 μm and a hydrophobic layer comprising a fluoropolymer and/or a poly(olefin); preferably wherein the hydrophobic coating is in contact with an aqueous environment/media.

In another embodiment, set forth herein is a composite structure comprising a substrate and a coating disposed on a surface of the substrate, wherein the coating comprises a layer comprising an amine-functionalized polymer having a uniform thickness of between about 1 μm to about 500 μm and a layer comprising a fluoropolymer and/or a poly(olefin); preferably wherein the hydrophobic coating is in contact with an aqueous environment/media. In some embodiments, the amine-functionalized polymer having a uniform thickness is a water-resistant adhesive. In some embodiments, the amine-functionalized polymer has a uniform thickness of greater than 80 μm. In some embodiments, the amine-functionalized polymer has a uniform thickness of at least 80 μm. In some embodiments, the amine-functionalized polymer has a uniform thickness of 80 μm to 150 μm. In some embodiments, the amine-functionalized polymer has a uniform thickness of at least 150 μm. In some embodiments, the amine-functionalized polymer has a uniform thickness of less than 500 μm. In some embodiments, the amine-functionalized polymer has a uniform thickness of less than 400 μm. In some embodiments, the amine-functionalized polymer has a uniform thickness of less than 300 μm. In some embodiments, the amine-functionalized polymer has a uniform thickness of less than 200 μm. In some embodiments, the coating is a hydrophobic coating. In some embodiments, the layer comprising a fluoropolymer, a poly(olefin) is hydrophobic.

In a third embodiment, set forth herein is a process for making a composite structure, comprising: applying an amine-functionalized polymer layer to a fluoropolymer and/or a poly(olefin) to form a coating; and applying the coating to a surface of a substrate to form a composite. In certain embodiments, the process includes applying an amine-functionalized polymer layer to a fluoropolymer to form a coating. In certain other embodiments, the process includes applying an amine-functionalized polymer layer to a poly(olefin) to form a coating. In some of these embodiments, the poly(olefin) is selected from the group consisting of high-density polyethylene (HDPE), low-density polyethylene (LDPE), and polypropylene (PP). In some examples, the poly(olefin) is HDPE. In some other examples, the poly(olefin) is LDPE. In some examples, the poly(olefin) is PP.

In a fourth embodiment, set forth herein is a process for making a composite structure, comprising: applying an amine-functionalized polymer layer to a surface of a substrate; and applying a fluoropolymer or a poly(olefin) to the amine-functionalized polymer layer. In certain embodiments, the process includes applying a fluoropolymer to the amine-functionalized polymer layer. In certain other embodiments, the process includes applying a poly(olefin) to the amine-functionalized polymer layer.

In a fifth embodiment, set forth herein is a process for making a composite structure, comprising: applying an amine-functionalized polymer layer to a surface of a substrate; and applying a polyurethane or epoxy-based paint to the amine-functionalized polymer layer. In certain embodiments, the paint may include additives to increase hydrophobicity. In some of these embodiments, the additives include a fluoropolymer additive. In some examples, the fluoropolymer is PTFE particles. In some of these examples, the fluoropolymer is PTFE particles having a particle size, P, wherein: 0.001 mm≤P≤0.1 mm. In some of these examples, the fluoropolymer is PTFE particles having a particle size greater than 0.001 mm. In some of these examples, the fluoropolymer is PTFE particles having a particle size greater than 0.1 mm. In some of these examples, the fluoropolymer is PTFE particles having a particle size less than 1 mm.

In a sixth embodiment, set forth herein is a process for making a composite structure, comprising: applying an amine-functionalized polymer layer to a surface of a substrate; and applying a fluoropolymer-based aerosol spray to the amine-functionalized polymer layer.

In a seventh embodiment, set forth herein is a process for repairing a composite structure, comprising providing, or having provided, a composite structure disclosed herein, wherein the composite structure has a defect; and applying pressure to repair the defect.

In an eight embodiment, set forth herein is a method of making a composite structure, comprising: a. applying an amine-functionalized polymer layer to a surface of a substrate; b. applying amine-functionalized polymer layer to a fluoropolymer and/or a poly(olefin) to form a coating; and b. joining the amine-functionalized polymer layers to form a composite.

### BRIEF DESCRIPTIONS OF THE DRAWINGS

FIG. 1 is a plot of peel strength as a function of external conditions.

FIG. 2 is a plot of lap sheer strength as a function of external conditions.

FIG. 3 is a plot of peel strength as a function of external conditions.

FIG. 4 is a plot of peel strength as a function of external conditions.

FIG. 5 is a plot of lap sheer strength as a function of external conditions.

FIG. 6 is a plot of peel strength as a function of external conditions.

FIG. 7(a) is a picture of a steel panel coated with an amine-functionalized polymer.

FIG. 7(b) is a picture of a steel panel coated with an amine-functionalized polymer followed by antifouling paint.

FIG. 7(c) is a picture of a steel panel coated with an amine-functionalized polymer followed by polyurethane paint.

FIG. 8 shows, on the left side, an amine-functionalized polymer sprayed on aluminum (Al) sheet, and on the right side, a DuPont Teflon aerosol sprayed as the topcoat over an amine-functionalized polymer coating.

### DETAILED DESCRIPTION

Provided herein are composite structures having hydrophobic, and in some embodiments, superhydrophobic coatings, articles including such composite structures, as well as methods of making and using such compositions. The composite structures comprise, in some embodiments, a substrate and a coating disposed on a surface of the substrate. In some examples, the coating is hydrophilic. In other examples, the coating is hydrophobic. The coating comprises, in some embodiments, an adhesive layer comprising an amine-functionalized polymer, and a hydrophobic layer comprising a fluoropolymer or a poly(olefin). In some embodiments, the substrate can be primed or unprimed, and can be large, irregular and/or uneven. In other embodiments, the substrate can be unmodified or pre-treated with another coating. In other embodiments, the substrate can be unmodified or pre-treated with another coating, and can be large, irregular and/or uneven. In some embodiments, the substrate is pre-treated by physical methods. In some of these embodiments, the physical methods include, but are not limited to, sand blasting, grit blasting, sand polishing, or grit polished. The hydrophobic coatings, and by extension the composite structures and/or articles described herein, exhibit anti-wetting, anti-fouling and self-healing properties and are useful for a variety of applications, including, but not limited to, drag reduction, as an anti-fouling surface in marine engineering, and as sealants and gaskets in static applications. The hydrophobic coatings, and by extension the composite structures and/or articles described herein may be used to prevent water and ice from wetting or sticking to the surfaces of materials and to reduce or prevent corrosion as well as marine bio-fouling.

As used herein, the term “hydrophobic” means and includes any material or surface with which water droplets have a contact angle in air of at least 90°, as measured by a contact angle goniometer as described in ASTM D7334-08. Furthermore, as used herein, the term “superhydrophobic” means and includes any material or surface with which water droplets have a contact angle in air of at least 150°, as measured by a contact angle goniometer as described in ASTM D7334-08. Thus, a “superhydrophobic” material will also be considered “hydrophobic;” however, a “hydrophobic” material may not necessarily be “superhydrophobic” in certain embodiments. In various embodiments, the hydrophobic coatings of the subject invention can comprise a contact angle in air of at least 90° or about 90°, at least 100° or about 100°, at least 110° or about 110°, or at least 120° or about 120°, at least 130° or about 130°, at least 140° or about 140°, at least 150° or about 150°, at least 160° or about 160°, or at least 170° or about 170°. In various embodiments, the hydrophobic coatings of the subject invention can comprise a contact angle in air of at 120° C. In various embodiments, the hydrophobic coatings of the subject invention can comprise a contact angle in air of 110-130°.

As used herein, “substrate” refers to flexible substrates; rigid substrates; and substrates made of, or which comprise, consist, or consist essentially of poly(tetrafluoro)ethylene (PTFE), polyolefins, metals (e.g. steel), metal composites, carbon fiber, releasable film, wood, fiberglass, composite materials, glass, rubber, ceramic, an adhesive film, paint, ship hulls, submarines, off-shore floating structures, fishing/aquaculture equipment, fishing/aquaculture installations, pipes/pipelines, drilling rigs, floating buoys, storage containers, any surface in contact with an aqueous environment, air/refrigeration systems and ducts, dams, bridges, and other civil constructions.

Suitable fluoropolymers for use in providing the hydrophobic coatings include, e.g., polytetrafluroroethylene (PTFE), polyvinylfluoride (PVF), polyvinylidene fluoride (PVDF), polychlorotrifluoroethylene (PCTFE), perfluoroalkoxy polymer (PFA), fluorinated ethylene-propylene (FEP), ethylene tetrafluoroethylene (ETFE) and related perfluoro elastomers. In embodiments, the PTFE may be porous, an unsintered film, or a thermally annealed, sintered film. Suitable poly(olefin)s for use in the subject invention include polypropylene (PP), polyethylene (PE), polybutadiene (PBD), polystyrene (PS), polyvinylchloride (PVC), and combinations thereof. In embodiments, the hydrophobic coating may comprise a combination of fluoropolymer and polyolefin. See, e.g., (ACSAppl. Mater. Interfaces 2016, DOI: 10.1021/acsami.5b12165). In some examples, the PTFE is a derivative of PTFE. In certain examples, the fluoropolymer is PTFE. In certain other examples, the fluoropolymer is PVF. In certain examples, the fluoropolymer is PVDF. In certain other examples, the fluoropolymer is PCTFE. In certain examples, the fluoropolymer is PFA. In certain other examples, the fluoropolymer is FEP. In certain examples, the fluoropolymer is ETFE. In certain other examples, the fluoropolymer is PVF. Porous, unsintered, and/or thermally annealed PTFE may be commercially purchased. For example, materials are available from Saint Gobain (https://www.plastics.saint-gobain.com/). See part numbers #128060WHT-FW and #SF00000540000C.

In some other embodiments, the hydrophobic/superhydrophobic coating applied to the adhesive layer (e.g., the amine-functionalized polymer layer) is a paint or similar type coating. In some of these embodiments, the hydrophobic/superhydrophobic coating is a paint and not just a fluoropolymer or polyolefin film.

In some embodiments, set forth herein is a multilayer composite. In some of these embodiments, one layer of the multilayer composite is a layer comprising steel. In some of these embodiments, the next, adjacent layer is an amine-functionalized polymer. In some of these embodiments, adjacent to the amine-functionalized polymer is a third layer which is the paint coating layer.

In some embodiments, set forth herein is a multilayer composite. In some of these embodiments, one layer of the multilayer composite is a layer comprising steel. In some of these embodiments, the next, adjacent layer is an amine-functionalized polymer. In some of these embodiments, adjacent to the amine-functionalized polymer is a third layer which is the spray coating layer.

In some embodiments, set forth herein is a multilayer composite. In some of these embodiments, one layer of the multilayer composite is a layer comprising steel. In some of these embodiments, the next, adjacent layer is an amine-functionalized polymer. In some of these embodiments, adjacent to the amine-functionalized polymer is a third layer which is the layer made from Teflon aerosol.

In some embodiments, set forth herein is a multilayer composite. In some of these embodiments, one layer of the multilayer composite is a layer comprising steel. In some of these embodiments, the next, adjacent layer is an amine-functionalized polymer. In some of these embodiments, adjacent to the amine-functionalized polymer is a third layer which is the layer made from PTFE (Teflon).

In some embodiments, including any of the foregoing, PTFE is included as an additive in a paint coating. See, for example, the paints at https://www.international-marine.com/product/intersleek-1100sr, which are herein incorporated by reference in their entirety for all purposes.

The substrate can be formed from any material known in the art, such as plastics, glass, fused silica, fiberglass, ceramic, metals, wood, fabrics, carbon fiber, fabrics and textiles, and the like. Examples of suitable substrates include polymer substrates, such as polydimethylsiloxane (PDMS), polyethylene terephthalate (PET), polycarbonate (PC), polyurea (PU), or combinations thereof; glass substrates; or metal substrates, such as steel (e.g., mild steel containing 0.15% to 0.23% carbon) or aluminum alloys; or a combination thereof. Substrates may also include concrete. The substrate can be in any configuration configured to facilitate formation of a coating suitable for use in a particular application. In exemplary embodiments, the substrate can be a releasable film. In certain embodiments, the substrate is steel. In certain other embodiments, the substrate is polyethylene. In certain embodiments, the substrate is concrete.

In certain embodiments, the hydrophobic coatings (and by extension the composite structures and articles described herein) exhibit both hydrophobic and oleophobic properties. In certain embodiments, the hydrophobic coatings (and by extension the composite structures and articles described herein) exhibit oleophobic properties. In certain embodiments, the hydrophobic coatings (and by extension the composite structures and articles described herein) exhibit hydrophobic properties. Coatings with surface tensions lower than that of water (72 mN/m) but higher than that of oils (20-30 mN/m) can attract oils (oleophilic) but repel water, whereas coatings with lower surface tensions (about 20 mN/m or less) will repel both oil (oleophobic) and water and are useful for anti-fouling such as in medical and transport applications. As such, these articles can exhibit various desirable properties, such as, for example, self-cleaning, anti-fouling, anti-smudge, and anti-icing properties. In some embodiments, the coating can impart microbial resistance to an article, moisture resistance to an article (e.g., metallic surface or other surfaces including wooden or ceramic surface), anti-fouling properties to an article (e.g., a surfaces, filters, membranes, or actuator). In some embodiments, including any of the foregoing, the coating can impart reduced friction and drag. In some embodiments, including any of the foregoing, the coating can provide a seal (e.g., a sealing valve). In some embodiments, including any of the foregoing, the article can be an amphibious vessel or personal watercraft (e.g. a ship, boat, submarine, or jet ski) or other floating and/or submersible device (e.g. buoy, dock, or drilling rig), an implantable device (e.g., a biochip, biosensor, or other medical device), an electrical device (rigid and stretchable printed circuit boards, telecommunications devices etc.), a pipeline, a building and construction material, apparel or textiles.

In some embodiments, including any of the foregoing, the amino-functionalized polymers, herein, may be used as an adhesive layer between a superhydrophobic surface and another surface.

In some embodiments, including any of the foregoing, the amino-functionalized polymers, herein, may be used to prime the surface of another substrate so that a third layer can be applied to the primed surface.

In some embodiments, including any of the foregoing, the amino-functionalized polymers, herein, may be used to promote the adhesion of two substrates, one of which is a superhydrophobic surface. In some embodiments, including any of the foregoing, this adhesion occurs underwater.

In some embodiments, including any of the foregoing, herein, the multilayer structure which includes an amino-functionalized polymer and a superhydrophobic surface may be self-healing. In some embodiments, including any of the foregoing, herein, the multilayer structure which includes an amino-functionalized polymer and a superhydrophobic surface may be used as a gap-filing material. In some of these embodiments, including any of the foregoing, if the multilayer structure which includes an amino-functionalized polymer and a superhydrophobic surface is damaged, then the multilayer structure may be repaired by pressing on the multilayer structure. In some embodiments, the pressing is accomplished using pressure applied from a human hand.

In some embodiments, including any of the foregoing, the uniform thickness is less than about 500 μm, less than about 450 μm, less than about 400 μm, less than about 350 μm, less than about 300 μm, or less than about 250 μm.

In some embodiments, including any of the foregoing, the uniform thickness is at least 200 μm.

In some embodiments, including any of the foregoing, the uniform thickness is between about 10 μm and 400 μm, between about 25 μm and about 300 μm, between about 50 μm and 250 μm, or between about 75 μm and 125 μm.

In some embodiments, including any of the foregoing, the adhesive layer is a film having a film thickness of 100 μm to 400 μm.

In some embodiments, including any of the foregoing, the adhesive layer is a film having a film thickness of 75 μm to 125 μm.

In some embodiments, including any of the foregoing, the hydrophobic layer is a film having a film thickness of 1 μm to 500 μm.

In some embodiments, including any of the foregoing, the hydrophobic layer is a film having a film thickness of 75 μm to 125 μm.

In some embodiments, including any of the foregoing, the hydrophobic layer is a film having a film thickness greater than 400 μm.

In some embodiments, including any of the foregoing, the uniform thickness is 100 μm to 400 μm.

In some embodiments, including any of the foregoing, the uniform thickness is 75 m to 125 μm.

In some embodiments, including any of the foregoing, the uniform thickness is 1 m to 500 μm.

In some embodiments, including any of the foregoing, the uniform thickness is 75 μm to 125 μm.

In some embodiments, including any of the foregoing, the uniform thickness is greater than 400 μm.

Suitable amine-functionalized polymers for use in the subject disclosure include those disclosed in co-pending International Patent Application Nos. PCT/CA2018/050619, PCT/CA2019/050704, and PCT/CA2018/050046, the disclosures of which are expressly incorporated by reference herein.

Suitable amine-functionalized polymers for use in the subject disclosure include those disclosed in U.S. Patent Application Publication No. US20210214542A1, the disclosures of which are expressly incorporated by reference herein.

Suitable amine-functionalized polymers for use in the subject disclosure include, but are not limited to, those disclosed in (a) Gilmour, D. J.; Tomkovic, T.; Kuanr, N.; Perry, M. R.; Gildenast, H.; Hatzikiriakos, S. G.; Schafer, L. L., Catalytic Amine Functionalization and Polymerization of Cyclic Alkenes Creates Adhesive and Self-Healing Materials. ACS Applied Polymer Materials 2021, 3, 2330-2335; (b) Kuanr, N.; Gilmour, D. J.; Gildenast, H.; Perry, M. R.; Schafer, L. L., Amine-Containing Monomers for Ring-Opening Metathesis Polymerization: Understanding Chelate Effects in Aryl- and Alkylamine-Functionalized Polyolefins. Macromolecules 2022; (c) Yavitt, B. M.; Tomkovic, T.; Gilmour, D. J.; Zhang, Z.; Kuanr, N.; van Ruymbeke, E.; Schafer, L. L.; and Hatzikiriakos, S. G., Rheology and self-healing of amine functionalized polyolefins. Journal of Rheology, 2022, 66, 1125-1137, the disclosures of each of which are expressly incorporated by reference herein.

Briefly, in embodiments, the subject amine-functionalized polymers may comprise, consist, or consist essentially of an amine-functionalized compound of Formula 2:

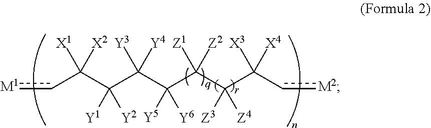

wherein (- - -) indicates an optional double bond;
wherein M¹ and M² are independently is —OH, a substituted or unsubstituted C₁₋₁₅ alkyl, a substituted or unsubstituted aromatic cycle, a substituted or unsubstituted heterocycle, or a functional end-group suitable for ring opening metathesis polymerization;
wherein each X¹, X², X³, and X⁴ is independently H or CH₃;
wherein each Y¹, Y², Y³, Y⁴, Y⁵, Y⁶, Z¹, Z², Z³, and Z⁴ is independently H, a substituted or unsubstituted linear or cyclic alkyl or alkenyl, a substituted or unsubstituted aryl, a substituted or unsubstituted heterocycle, an amine-compatible protection group, —C(═O)R′, or —C(OR′)R″, and wherein at least one of Y¹, Y², Y³, Y⁴, Y⁵, Y⁶, Z¹, Z², Z³, and Z⁴ is —CRR²—NR³R⁴;
wherein each of R′, R″, R¹, R², R³ and R⁴ is independently H, a substituted or unsubstituted linear or cyclic alkyl or alkenyl, a substituted or unsubstituted aryl, a substituted or unsubstituted heterocycle, or an amine-compatible protection group;
wherein r=0 or 1 and q=0 or 1, wherein r+q=0, 1, or 2; and
wherein n is a natural number greater than 1 and less than 10,000,000,000.

Aspects of the disclosure pertain to block copolymers comprising: an amine functionalized compound as described above; and a polymer formed by radical or anionic polymerization, for which the functional end-groups M¹ and M² of the amine functionalized compound serves as an initiation point.

A block copolymer prepared comprising: an amine functionalized compound as described above; and at least one additional polymer.

In embodiments, the subject amine-functionalized polymers may comprise, consist, or consist essentially of an amine-functionalized compound of Formula 3:

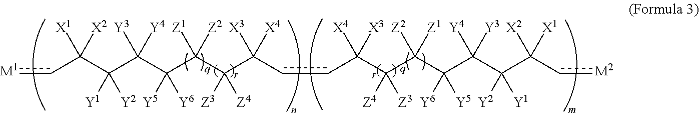

wherein (- - -) indicates an optional double bond;
wherein M¹ and M² are independently is —OH, a substituted or unsubstituted C₁₋₅ alkyl, a substituted or unsubstituted aromatic cycle, a substituted or unsubstituted heterocycle, or a functional end-group suitable for ring opening metathesis polymerization;
wherein each X¹, X², X³, and X⁴ is independently H or CH₃;
wherein each Y¹, Y², Y³, Y⁴, Y⁵, Y⁶, Z¹, Z², Z³, and Z⁴ is independently H, a substituted or unsubstituted linear or cyclic alkyl or alkenyl, a substituted or unsubstituted aryl, a substituted or unsubstituted heterocycle, an amine-compatible protection group, —C(═O)R′, or —C(OR′)R″, and wherein at least one of Y¹, Y², Y³, Y⁴, Y⁵, Y⁶, Z¹, Z², Z³, and Z⁴ is —CR¹R²—NR³R⁴;
wherein each of R′, R″, R¹, R², R³ and R⁴ is independently H, a substituted or unsubstituted linear or cyclic alkyl or alkenyl, a substituted or unsubstituted aryl, a substituted or unsubstituted heterocycle, or an amine-compatible protection group;
wherein r=0 or 1 and q=0 or 1, wherein r+q=0, 1, or 2;
wherein n and m are natural numbers; and
wherein the monomers are connected in a head-to-head fashion.

In embodiments, the subject amine-functionalized polymers may comprise, consist, or consist essentially of an amine-functionalized compound of Formula X:

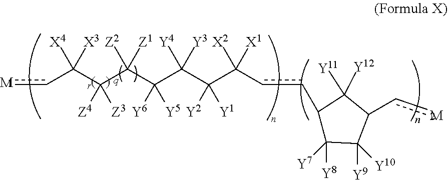

wherein (- - -) indicates an optional double bond;
wherein M¹ and M² are independently is —OH, a substituted or unsubstituted C₁₋₅ alkyl, a substituted or unsubstituted aromatic cycle, a substituted or unsubstituted heterocycle, or a functional end-group suitable for ring opening metathesis polymerization;
wherein each X¹, X², X³, and X⁴ is independently H or CH₃;
wherein each Y¹, Y², Y³, Y⁴, Y⁵, Y⁶, Y⁷, Y⁸, Y⁹, Y¹⁰, Y¹¹, Y¹², Z¹, Z², Z³, and Z⁴ is independently H, a substituted or unsubstituted linear or cyclic alkyl or alkenyl, a substituted or unsubstituted aryl, a substituted or unsubstituted heterocycle, an amine-compatible protection group, —C(═O)R′, or —C(OR′)R″, and wherein at least one of Y¹, Y², Y³, Y⁴, Y⁵, Y⁶, Z¹, Z², Z³, and Z⁴ is —CR¹R²—NR³R⁴;
wherein each of R′, R″, R¹, R², R³ and R⁴ is independently H, a substituted or unsubstituted linear or cyclic alkyl or alkenyl, a substituted or unsubstituted aryl, a substituted or unsubstituted heterocycle, or an amine-compatible protection group;
wherein r=0 or 1 and q=0 or 1, wherein r+q=0, 1, or 2;
wherein n and m are natural numbers;
In embodiments, the subject amine-functionalized polymers may comprise, consist, or consist essentially of an amine-functionalized compound of Formula 6:

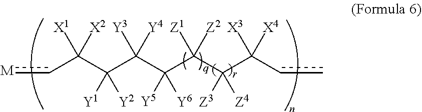

wherein (- - -) indicates an optional double bond;
wherein each X¹, X², X³, and X⁴ is independently H or CH₃;
wherein each Y¹, Y², Y³, Y⁴, Y⁵, Y⁶, Z¹, Z², Z³, and Z⁴ is independently H, a substituted or unsubstituted linear or cyclic alkyl or alkenyl, a substituted or unsubstituted aryl, a substituted or unsubstituted heterocycle, an amine-compatible protection group, —C(═O)R′, or —C(OR′)R″, and wherein at least one of Y¹, Y², Y³, Y⁴, Y⁵, Y⁶, Z¹, Z², Z³, and Z⁴ is —CR¹R²—NR³R⁴;
wherein each of R′, R″, R¹, R², R³ and R⁴ is independently H, a substituted or unsubstituted linear or cyclic alkyl or alkenyl, a substituted or unsubstituted aryl, a substituted or unsubstituted heterocycle, or an amine-compatible protection group; and
wherein r=0 or 1 and q=0 or 1, wherein r+q=0, 1, or 2.

Aspects of the disclosure pertain to a brush copolymer comprising a polymer as described above and polymeric bristles or brushes, wherein at least one of X¹, X², X³, X⁴, Y¹, Y², Y³, Y⁴, Y⁵, Y⁶, Z¹, Z², Z³, Z⁴, R′, R″, R¹, R², R³, and R⁴ serves as an initiation point for subsequent synthesis of polymeric bristles or brushes.

In certain embodiments, including any of the foregoing, the compound of formula 2 comprises Y³ or Y⁴ as —CR¹R²—NR³R⁴; wherein R³ or R⁴ are each, independently, a substituted or unsubstituted aryl. In some embodiments, either q or r is 0. In some embodiments, q is 0 and r is 1. In some other embodiments, q is 1 and r is 0.

In certain embodiments, including any of the foregoing, the compound of formula 6 comprises Y³ or Y⁴ as —CR¹R²—NR³R⁴; wherein R³ or R⁴ are each, independently, a substituted or unsubstituted aryl. In some embodiments, either q or r is 0. In some embodiments, q is 0 and r is 1. In some other embodiments, q is 1 and r is 0.

In certain embodiments, including any of the foregoing, the compound of formula 2 comprises Y³ or Y⁴ as —CR¹R²—NR³R⁴; wherein R³ or R⁴ are each, independently, a substituted or unsubstituted phenyl. In some embodiments, either q or r is 0. In some embodiments, q is 0 and r is 1. In some other embodiments, q is 1 and r is 0.

In certain embodiments, including any of the foregoing, the compound of formula 6 comprises Y³ or Y⁴ as —CR¹R²—NR³R⁴; wherein R³ or R⁴ are each, independently, a substituted or unsubstituted benzyl. In some embodiments, either q or r is 0. In some embodiments, q is 0 and r is 1. In some other embodiments, q is 1 and r is 0.

In certain embodiments, including any of the foregoing, the compound of formula 2 comprises Y³ or Y⁴ as —CR¹R²—NR³R⁴; wherein R³ or R⁴ are phenyl. In some embodiments, either q or r is 0. In some embodiments, q is 0 and r is 1. In some other embodiments, q is 1 and r is 0.

In certain embodiments, including any of the foregoing, the compound of formula 6 comprises Y³ or Y⁴ as —CR¹R²—NR³R⁴; wherein R³ or R⁴ are benzyl. In some embodiments, either q or r is 0. In some embodiments, q is 0 and r is 1. In some other embodiments, q is 1 and r is 0.

In certain embodiments, including any of the foregoing, the compound of formula 2 comprises Y³ or Y⁴ as —CR¹R²—NR³R⁴; wherein R³ and R⁴ are both phenyl. In some embodiments, either q or r is 0. In some embodiments, q is 0 and r is 1. In some other embodiments, q is 1 and r is 0.

In certain embodiments, including any of the foregoing, the compound of formula 6 comprises Y³ or Y⁴ as —CR¹R²—NR³R⁴; wherein R³ and R⁴ are both benzyl. In some embodiments, either q or r is 0. In some embodiments, q is 0 and r is 1. In some other embodiments, q is 1 and r is 0.

In some embodiments, Y³ or Y⁴ is CH₂—NH-Ph. Herein Ph is phenyl. In some other embodiments, q is 1 and r is 0.

In some embodiments, Y³ or Y⁴ is CH₂—NH-Ph-F. Herein Ph is phenyl. In some other embodiments, q is 1 and r is 0.

In some embodiments, Y³ or Y⁴ is CH₂—NH-Ph-OH₃. Herein Ph is phenyl. In some other embodiments, q is 1 and r is 0.

Aspects of the disclosure pertain to an amine functionalized polyalkylene or polyalkane, wherein the polyalkylene or polyalkane is or includes:

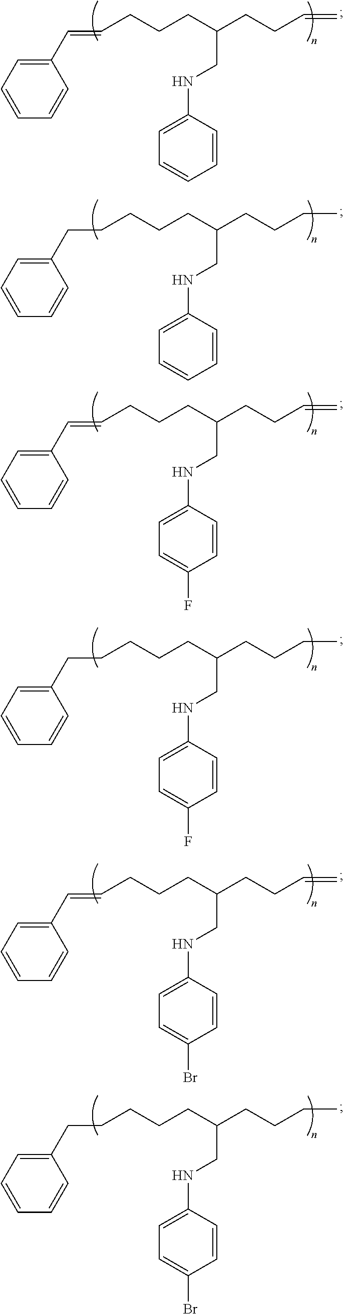

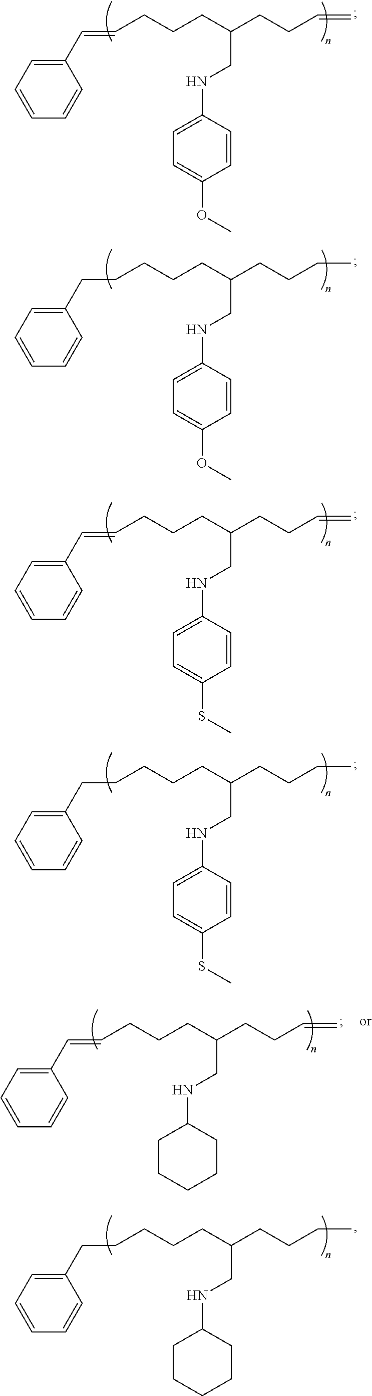

wherein n is a natural number greater than 1 and less than 500,000. In some embodiments, n is less than 100,000.

In some embodiments, the amine functionalized polyalkylene or polyalkane, is or includes:

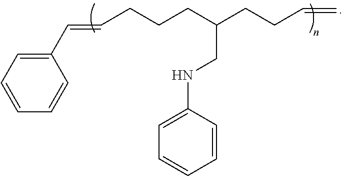

In some embodiments, the amine functionalized polyalkylene or polyalkane, is or includes:

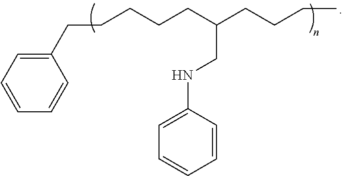

Aspects of the disclosure pertain to co-polymers comprising a mixture of different amine-functionalized monomer units of Formula 5:

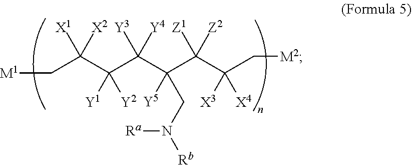

wherein M¹ and M² are, each, selected from —OH, a substituted or unsubstituted C₁₋₁₅ alkyl, a substituted or unsubstituted aromatic cycle, a substituted or unsubstituted heterocycle, or a functional end-group suitable for ring opening metathesis polymerization;
wherein each of X¹, X², X³, and X⁴ is independently H or CH₃;
wherein each of Y¹, Y², Y³, Y⁴, Y⁵, Z¹, and Z² is independently H, a substituted or unsubstituted linear or cyclic alkyl or alkenyl, a substituted or unsubstituted aryl, a substituted or unsubstituted heterocycle, an amine-compatible protection group, —C(═O)R′, or —C(OR′)R″;
wherein each of R′, R″, Ra, R¹, R², R³ and R⁴ is independently H, a substituted or unsubstituted linear or cyclic alkyl or alkenyl, a substituted or unsubstituted aryl, a substituted or unsubstituted heterocycle, or an amine-compatible protection group; or
wherein R′ or R″ is —CR¹R²—NR³R⁴,
wherein r=0 or 1 and q=0 or 1, wherein r+q=0, 1, or 2; and
wherein n is a natural number greater than 1. In some embodiments, n is less than 100,000.

In embodiments, the subject amine-functionalized polymers may comprise, consist, or consist essentially of an amine-functionalized compound of:

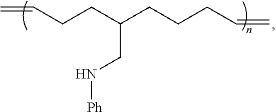

wherein subscript n is an integer greater than 1 and less than 100,000,000,000. In some embodiments, n is less than 100,000.

In embodiments, the subject amine-functionalized polymers may comprise, consist, or consist essentially of an amine-functionalized compound which includes as a portion of the polymer the following structure:

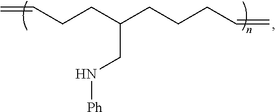

wherein subscript n is an integer an integer greater than 1 and less than 100,000,000,000. In some embodiments, n is less than 100,000.

### F. EXAMPLES

### Polymer Synthesis

Poly(amino-cyclooctenes) were prepared according to a published method (Gilmour, D. J. et al., ACS Applied Polymer Materials 2021, 3 (5), 2330-2335). In brief, poly(amino-cyclooctenes) are prepared via the ring-opening metathesis polymerization (ROMP) of amine-functionalized cyclooctene monomers that are in turn prepared via hydroaminoalkylation of cyclooctadiene with a secondary methylamine, for example N-methyl aniline. Polymers were isolated and purified according to published protocols. Polymer solutions for spray application were prepared by dissolving the material in a suitable carrier solvent, for example dichloromethane.

### Polymer Characterization

Polymers were analyzed by conventional chemical characterization techniques for polymers, including NMR spectroscopy, IR spectroscopy, gel-permeation chromatography (GPC), differential scanning calorimetry (DSC), and thermal gravimetric analysis (TGA) etc. ¹H NMR spectra were collected using a Bruker Avance instrument operating at 300 or 400 MHz. IR Spectra were recorded at room temperature on a Perkin Elmer FTIR equipped with an ATR accessory for direct measurement on oils and polymeric materials. Polymer Mn, Mw and dispersity (D) were obtained using triple detection gel permeation chromatography (GPC). All the GPC characterizations were done in HPLC-grade THF at a flow rate of 1.0 mL/min using a Malvern OMNISEC GPC instrument equipped with a Viscotek TGuard guard column (CLM3008), and Viscotek T3000 (CLM3003) and T6000 (CLM3006) GPC columns packed with porous poly(styrene-co-divinylbenzene) particles regulated at a room temperature. The instrument was equipped with triple detection to achieve the signal response from differential viscometer, differential refractive index and right-angle & low-angle light scattering detectors. Thermal properties of the samples were measured on a Netzsch DSC 214 Polyma differential scanning calorimeter. Netzsch TG 209 F1 Libra® thermogravimetric analyzer was used for the thermogravimetric experiments.

### Adhesive Properties

Adhesion was quantified using a Dynamic Mechanical analyzer (DMA, RSA G2 TA Instruments) equipped with tension fixture to perform peel strength measurements. A solution of polymer was applied via spray between two substrates and after drying the two sheets of PTFE were placed into contact with minimal pressure by hand. Test specimens were prepared in accordance with the DMA instrument specifications, 6 mm wide and 17 mm long. Untreated tabs of 20 mm in length were used to clamp the unbonded peel arms onto the tension fixture. A constant peel rate of 10 mm/min at room temperature was applied in axial mode. The testing was repeated ten times.

Specimens for wet testing were prepared and tested with HDPE (BCT-195357 Exxon) and PTFE (08277-15 5 mil Skived Cole Parmer). A sample of polymer was dissolved in dichloromethane to give a solution of approximately 7.5 wt % (m/v). Immediately after adhered samples were prepared, they were soaked for 21 days in a given solution (distilled water, ocean water, 8 M HCl, 8 M NaOH). After storage samples were analyzed for adhesive properties using the DMA equipped with an immersion cell.

### Example 1

Formulation: an optimized spray application process where the solution viscosity and concentration are modified to obtain adhesive films of various thickness. An optimum solution viscosity and concentration has been determined to obtain homogeneous (i.e., even) films. A threshold value for film thickness to reach maximum adhesive strength has been determined.

Thickness may be controlled by the amount of material deposited.

Ability to apply the adhesive to an underwater substrate. Polymer solution can be delivered using a syringe or other delivery method to a substrate that is underwater and subsequently when coated can be adhered to a second substrate. Samples can also be prepared under dry conditions then immersed in solutions.

Remarkably, as demonstrated herein for the first time, the subject adhesives can be reversibly applied and/or re-used. When adhered objects are separated, they can be re-combined to ‘self-heal’ or regenerate the original adhesive strength when they were first bonded. This feature is realized through a combination of the polymer's adhesive and self-healing properties.

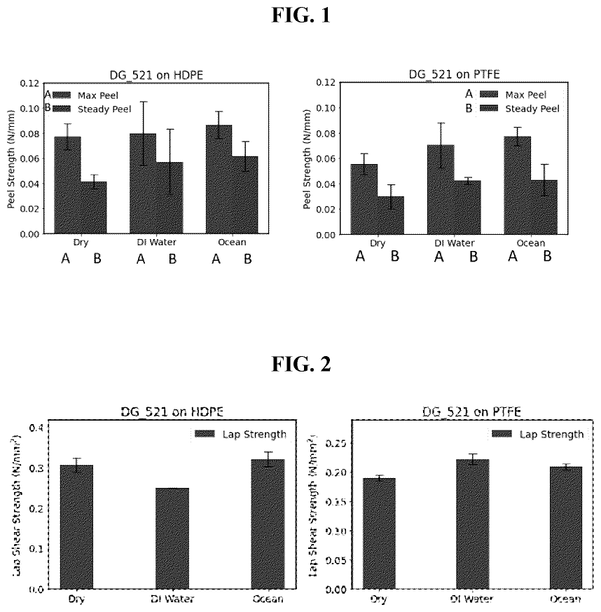

Samples of HDPE that were adhered using the polymer adhesive showed no difference in T-peel force when stored in deionized or ocean water as compared to the dry condition. On samples of PTFE, T-peel force for dry and deionized submersion were approximately equal within experimental error; however, storage in ocean water led to a modest increase in T-peel force. In lap-shear configuration, no significant differences were observed on HDPE, while in PTFE modest increases in lap-shear strength were observed in samples immersed in deionized or ocean water. Without being bound by theory, it may be that in ocean water, the presence of ions such as salts, metals, etc. and inorganic particulate leads to improved cohesive strength of the polymer, perhaps by ion chelation mediated cross-linking. As the bond failure mode is observed to be cohesive, vs adhesive failure, this is indicative that the strength of bonding at the interface of the polymer and substrate is greater than that of the tensile strength of the material. Since cohesive failure mode is observed in samples under immersion, it suggests that the presence of ions at the surface does not lead to decreased surface attachment. See FIGS. 1 and 2.

### Example 2

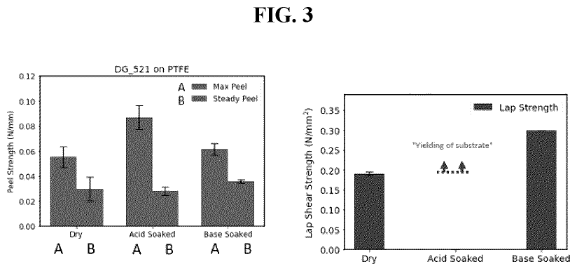

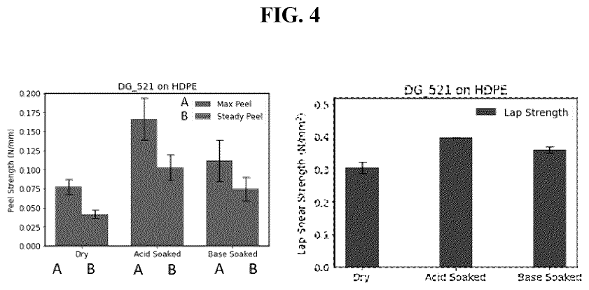

A highly challenging environment for conventional adhesives are highly acidic or alkaline environments. Samples of HDPE and PTFE were prepared and tested after immersion in highly acidic or highly alkaline solutions and compared to dry environment controls. With both PTFE and HDPE, modest increases in T-peel and lap shear adhesive force were observed after storage in alkaline condition. In acidic solutions, a significant increase in T-peel and lap-shear force was observed after immersion. Without being bound by theory, it may be that the amine groups of the polymer adhesive are able to promote ionic interactions with hydronium ions in solution that lead to increased cohesive strength. See FIGS. 3 and 4.

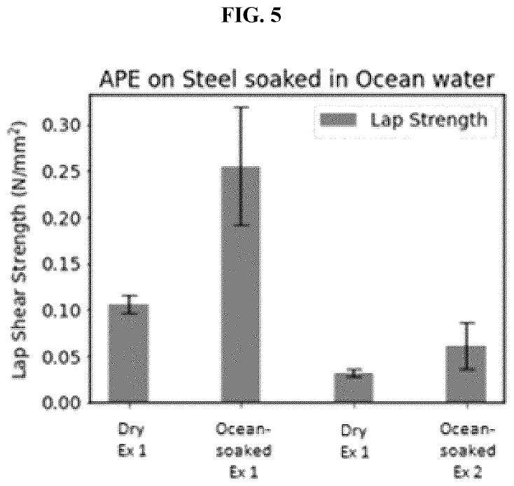

The polymer adhesive was also applied to raw untreated steel coupons and tested in a shear lap configuration. Storage in ocean water led to a significant increase in lap-shear strength. The incidence of corrosion occurs rapidly to steel in ocean water; it is hypothesized that iron ions liberated from corrosion of the steel led to an enhanced improvement in peel strength due to metal ion chelation. This suggests improved adhesion can be obtained in the presence of corrosive environments. See FIG. 5

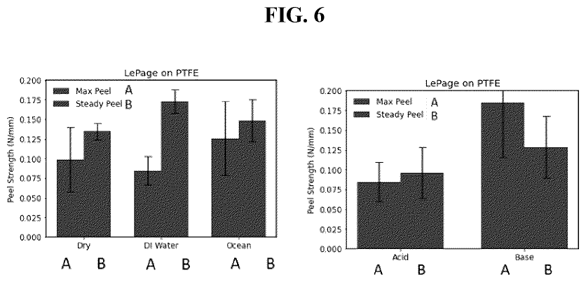

A comparison was also made with the performance of a commercial glue (LePage Plastic Bonder) under the immersion conditions. Visually the samples appeared to deteriorate, and unlike the present invention the samples could not be re-joined after peeling apart. See FIG. 6.

### Example 3

This Example is a process for using a multilayer amine-functionalized polymer and commercial paint coatings.

Multilayer amine-functionalized polymer—commercial paint coatings were obtained by first applying amine-functionalized polymer via a dissolved solution of the polymer in dichloromethane (conc.=75 mg/ml) using a spray process on P110 steel panels having dimensions of 8″×24″. After the spraying, the amine-functionalized polymer coating was dried for at least 24 h at room temperature prior to the application of the commercial paint. Amine-functionalized polymer coating had a thickness of approx. 0.1 mm. Two commercial paint systems have been demonstrated, AkzoNobel Interlux® Bottomkote® XXX Anti-fouling Paint, and Epifanes Poly-urethane 2-component Yacht Coating. The commercial paints were painted onto the amine-functionalized polymer-coated steel panels using a paintbrush following the application specifications for the product. After painting the coated panels were died at room temperature for at least 48 h before immersion.

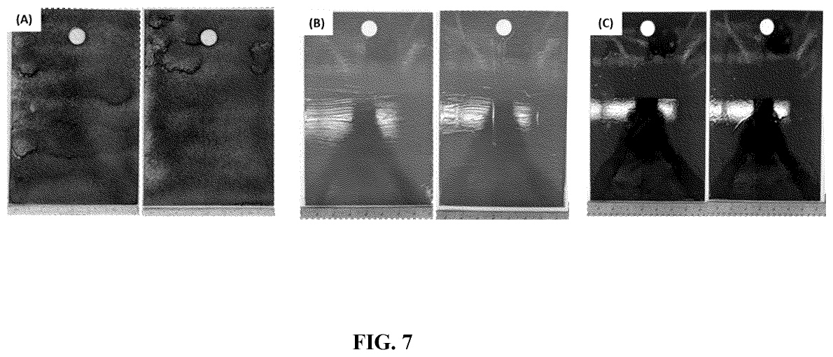

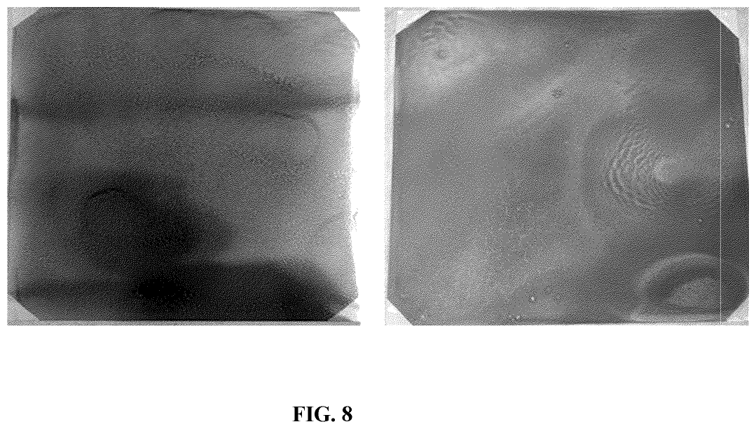

The results are shown in FIG. 7(a), FIG. 7(b), and FIG. 7(c).

Amine-functionalized polymer bottom coat—DuPont Teflon spray topcoat: Amine-functionalized polymer (0.1 mm thickness) was first sprayed onto a flat aluminium sheet 6″×6″. After the coating was dried for 24 hours at room temperature DuPont Non-stick Dry Film Lubricant with Teflon fluoropolymer aerosol was sprayed on the amine-functionalized polymer coating. The entire amine-functionalized polymer coating was covered with the Teflon spray and was allowed to dry for 24 hours.

The results are shown in FIG. 8.

The embodiments and examples described above are intended to be merely illustrative and non-limiting. Those skilled in the art will recognize or will be able to ascertain using no more than routine experimentation, numerous equivalents of specific compounds, materials and procedures. All such equivalents are considered to be within the scope and are encompassed by the appended claims. Further, while only certain representative materials and method steps disclosed herein are specifically described, other combinations of the materials and method steps also are intended to fall within the scope of the appended claims, even if not specifically recited. Thus, a combination of steps, elements, components, or constituents may be explicitly mentioned herein; however, other combinations of steps, elements, components, and constituents are included, even though not explicitly stated.

The term “comprising” and variations thereof as used herein is used synonymously with the term “including” and variations thereof and are open, non-limiting terms. Although the terms “comprising” and “including” have been used herein to describe various embodiments, the terms “consisting essentially of” and “consisting of” can be used in place of “comprising” and “including” to provide for more specific embodiments and are also disclosed. As used in this disclosure and in the appended claims, the singular forms “a”, “an”, “the”, include plural referents unless the context clearly dictates otherwise.

What is claimed is:

1. A composite structure comprising a substrate and a coating disposed on a surface of the substrate,
wherein the coating comprises a layer comprising an amine-functionalized polymer having a uniform thickness of between about 1 μm to about 500 μm and a layer comprising a fluoropolymer, a poly(olefin), or a combination thereof; and
wherein the hydrophobic coating is in contact with an aqueous environment/media.

2. The composite structure of claim 1, wherein the coating is a hydrophobic coating.

3. The composite structure of claim 1 or 2, wherein the layer comprising a fluoropolymer, a poly(olefin) is hydrophobic.

4. The composite structure of any one of claims 2-3, wherein the hydrophobic coating is immersed in the aqueous environment/media.

5. The composite structure of any one of claims 1-4, wherein the composite structure is submerged in the aqueous environment/media.

6. The composite structure of any one of claims 1-5, wherein the substrate comprises a secondary adhesive agent optionally wherein said secondary adhesive agent comprises a polyurethane paint.

7. The composite structure of any one of claims 1-6, wherein said uniform thickness is at least about 10 μm, at least about 20 μm, at least about 30 μm, at least about 40 μm, at least about 50 μm, at least about 60 μm, at least about 70 μm, at least about 80 μm, at least about 90 μm, or at least about 100 μm.

8. The composite structure of any one of claims 1-7, wherein said uniform thickness is less than about 500 μm, less than about 450 μm, less than about 400 μm, less than about 350 μm, less than about 300 μm, or less than about 250 μm.

9. The composite structure of claim 8, wherein the uniform thickness is at least 200 μm.

10. The composite structure of any one of claims 1-9, wherein said uniform thickness is between about 10 μm and 400 μm, between about 25 μm and about 300 μm, between about 50 μm and 250 μm, or between about 75 μm and 125 μm.

11. The composite structure of any one of claims 1-10, wherein the adhesive layer is a film having a film thickness of 100 μm to 400 μm.

12. The composite structure of claim 11, wherein the adhesive layer is a film having a film thickness of 75 μm to 125 μm.

13. The composite structure of any one of claims 1-12, wherein the hydrophobic layer is a film having a film thickness of 1 μm to 500 μm.

14. The composite structure of claim 13, wherein the hydrophobic layer is a film having a film thickness of 75 μm to 125 μm.

15. The composite structure of any one of claims 1-14, wherein the hydrophobic layer is a film having a film thickness greater than 400 μm.

16. The composite structure of any one of claims 1-15, wherein said uniform thickness is 100 μm to 400 μm.

17. The composite structure of claim 16, wherein said uniform thickness is 75 μm to 125 μm.

18. The composite structure of any one of claims 1-17, wherein said uniform thickness is 1 μm to 500 μm.

19. The composite structure of claim 18, wherein said uniform thickness is 75 μm to 125 μm.

20. The composite structure of any one of claims 1-19, wherein said uniform thickness is greater than 400 μm.

21. The composite structure of any one of claims 1-20, wherein the fluoropolymer is selected from the group consisting of polytetrafluroroethylene (PTFE), polyvinylfluoride (PVF), polyvinylidene fluoride (PVDF), polychlorotrifluoroethylene (PCTFE), perfluoroalkoxy polymer (PFA), fluorinated ethylene-propylene (FEP), and related perfluoro elastomers.

22. The composite structure of claim 21, wherein the PTFE is porous.

23. The composite structure of claim 21, wherein the PTFE is an unsintered film.

24. The composite structure of claim 21, wherein the PTFE is a thermally annealed, sintered film.

25. The composite structure of any one of claims 1-24, wherein the poly(olefin) is selected from the group consisting of polypropylene (PP), polyethylene (PE), polybutadiene (PBD), polystyrene (PS), polyvinylchloride (PVC), and combinations thereof.

26. The composite structure of any one of claims 1-25, wherein the hydrophobic coating is superhydrophobic.

27. The composite structure of any one of claims 1-26, wherein the substrate is a release film.

28. The composite structure of any one of claims 1-27, wherein the substrate is the hull of a boat, ship, submarine, or personal watercraft.

29. The composite structure of any one of claims 1-28, wherein the adhesive layer is a film having a length of at least 50 mm.

30. The composite structure of any one of claims 1-29, wherein the hydrophobic layer is a film having a length of at least 50 mm.

31. The composite structure of any one of claims 1-30, wherein the adhesive layer has a homogenous composition.

32. The composite structure of any one of claims 1-31, wherein the hydrophobic layer has a homogeneous composition.

33. The composite structure of any one of claims 1-32, wherein the substrate is flexible.

34. The composite structure of any one of claims 1-33, wherein the substrate is rigid.

35. The composite structure of any one of claims 1-34, wherein the substrate is a release film.

36. The composite structure of claim 35, wherein release film is poly-dimethyl-siloxane (PDMS), PDMS/silicone, silicone, a vinyl adhesive, or a combination thereof.

37. The composite structure of any one of claims 1-36, wherein the substrate comprises a secondary coating layer, optionally wherein the secondary coating layer comprises a secondary adhesive agent, a paint primer, or a coating that protects the hull.

38. The composite structure of claim 37, wherein the secondary adhesive agent is selected from the group consisting of polyurethane, acrylic, cyanoacrylate, and an epoxy.

39. The composite structure of claim 37, wherein the coating that protects the hull is scratch-resistant layer, or a barrier coating for corrosion and fouling resistance.

40. An article comprising the composite structure according to any one of claims 1-39.

41. The article of claim 40, wherein said article is in contact with or immersed in an aqueous environment.

42. The article according to claim 41, wherein said article is a boat, ship, submarine, personal watercraft, buoy, dock, or drilling rig.

43. A method of making a composite structure, comprising:
a. applying amine-functionalized polymer layer to a fluoropolymer and/or a poly(olefin) to form a coating; and
b. applying the coating to a surface of a substrate to form a composite.

44. A method of making a composite structure, comprising:
a. applying an amine-functionalized polymer layer to a surface of a substrate; and
b. applying a fluoropolymer or a poly(olefin) to the amine-functionalized polymer layer.

45. A method of making a composite structure, comprising applying a combination of an amine-functionalized polymer and a fluoropolymer and/or a poly(olefin) to a surface of a substrate.

46. A method of repairing a composite structure, comprising
a. providing, or having provided, a composite structure of any one of claims 1-39, wherein the composite structure has a defect; and
b. applying pressure to repair the defect.

47. The methods of any one of claims 43-46, comprising spraying PTFE as a solution or as a dry spray particle.

48. A method of making a composite structure, comprising:
a. applying an amine-functionalized polymer layer to a surface of a substrate; and
b. applying a paint coating to the amine-functionalized polymer layer.

49. The method of claim 48, wherein the paint coating is an anti-fouling paint coating.

50. The method of claim 48 or 49, wherein the paint coating comprises a hydrophobic additive.

51. The method of claim 48 or 49, wherein the paint coating comprises PTFE.

52. A method of making a composite structure, comprising:
a. applying an amine-functionalized polymer layer to a surface of a substrate;
b. applying amine-functionalized polymer layer to a fluoropolymer, a poly(olefin), or a combination thereof, to form a coating; and
b. joining the amine-functionalized polymer layers to form a composite.

48. The method of any one of claims 43-46, wherein the method is performed in the order in which the steps are recited.
